(19) United States
(12) Patent Application Publication
(10) Pub. No.: US 2014/0305423 A1
(43) Pub. Date: Oct. 16, 2014

(54) PALMTOP CHARCOAL IGNITER

(71) Applicant: Chiao-Lien Tang, Taipei (TW)

(72) Inventor: Chiao-Lien Tang, Taipei (TW)

(21) Appl. No.: 14/247,797

(22) Filed: Apr. 8, 2014

(30) Foreign Application Priority Data
Apr. 13, 2013 (CN) 201320213879.9

(51) Int. Cl. A47J 37/07; F24B 15/00

(52) U.S. Cl. CPC A47J 37/079; F24B 15/005
USPC 126/25 B

(57) ABSTRACT

A palmtop charcoal igniter includes a protective aluminum pipe, a heat insulation stainless steel pipe sleeved in the protective aluminum pipe, a mica sleeve mounted in the heat insulation stainless steel pipe, a heating body mounted in the mica sleeve and comprising an insulating mica pipe and a mica support, a handle mounted outside the heat insulation stainless steel pipe, and an igniter switch disposed on a top end of the handle and configured with three shifts including an on-off shift, a cold air shift and a hot air shift. The on-off function and the exchange of cold/hot air can be realized via the on-off control of the three shifts.

### BACKGROUND OF THE INVENTION

1. Field of the Invention

The present invention relates to a palmtop charcoal igniter.

2. Description of the Prior Art

Conventionally, a hot air shift device is the only element provided in similar igniters. After a long term usage of the hot air, the temperatures of an interior and metallic portions of a wire heater of the igniter are high, and thus a long cooling time for the wire heater is required. Besides, wires of the wire heater are easily broken due to the high temperature of the interior of the wire heater, and the mica pipe is easily ruptured due to high temperature. Furthermore, in the operation process of continuously using the hot air to support combustion, the consumption of electric energy is greatly increased, and peripheral facilities are correspondingly required, so that the procurement costs cannot be effectively decreased.

### SUMMARY OF THE INVENTION

The main purpose of the invention is to provide a palmtop charcoal igniter. The palmtop charcoal igniter comprises a protective aluminum pipe externally configured with multiple rows of heat dissipation holes and having a front end disposed with an exhaust port, a heat insulation stainless steel pipe sleeved in the protective aluminum pipe, a mica sleeve mounted in the heat insulation stainless steel pipe, a heating body mounted in the mica sleeve and comprising an insulating mica pipe and a mica support, a handle mounted outside the heat insulation stainless steel pipe and comprising a handle right shell and a handle left shell, a motor mounted in the handle, a motor support disposed on a front end of the motor and allowing the motor passed therethrough and fixed therewith, a wind blade mounted on a front end of the motor support, a fan cover disposed on a front end of the wind blade, an igniter switch disposed on a top end of the handle and configured with three shifts including an on-off shift, a cold air shift and a hot air shift, a relatively large-sized wire heater winded around a front end of the mica support of the heating body and connected to the igniter switch, a relatively small-sized wire heater winded around a rear end of the relatively large-sized wire heater and connected to the igniter switch, a temperature control switch mounted on a rear end of the relatively small-sized wire heater and connected to the igniter switch, and a supporting frame mounted on the protective aluminum pipe and a lower end of the handle.

In one aspect of the invention, the supporting frame has a W-shaped bended structure, capable of being conveniently placed at different planes. With the design of the front-end opening of the W-shaped supporting frame of the invention, wine bottle caps or coverings of other beverage products can be easily opened by a user.

In one aspect of the invention, the exhaust port of the protective aluminum pipe has a straight opened structure, capable of greatly increasing the heat transferring rate to effectively promote working efficiency.

Efficacies of the palmtop charcoal igniter of the invention can be provided as follows.

With the additional cold air function of the invention, the user can apply the cold air for supporting combustion after charcoals, woods or other combustible matters passing through the hot air point are ignited, thereby facilitating the combustion speed of the combustible matters, avoiding of continuously using the hot air to support combustion, and saving electric energy.

Secondly, according to the additional cold air function of the invention, the user can selectively use a cold air mode or a hot air mode in the same product, viz this product capable of providing the cold or hot air for the user, thus to save the procurement costs.

Thirdly, because the temperatures of the interior and metallic portions of the wire heater are high when applying the hot air to ignite the charcoal, woods or other combustible matters, a relatively long cooling time for the wire heater is required. It is appreciated that the additional cold air function of the invention is suitable for cooling the high temperature parts of the product rapidly. Besides, by using the cold air to rapidly cool the high temperature parts of the wire heater, wires of the wire heater can be prevented from being broken due to the high temperature of the interior thereof and the mica pipe can be prevented from being ruptured due to high temperature, thereby greatly extending the life service of the product.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is an exploded perspective view of the invention; and

FIG. 2 is a structural schematic view of a heating body of the invention.

### DETAILED DESCRIPTION OF THE INVENTION

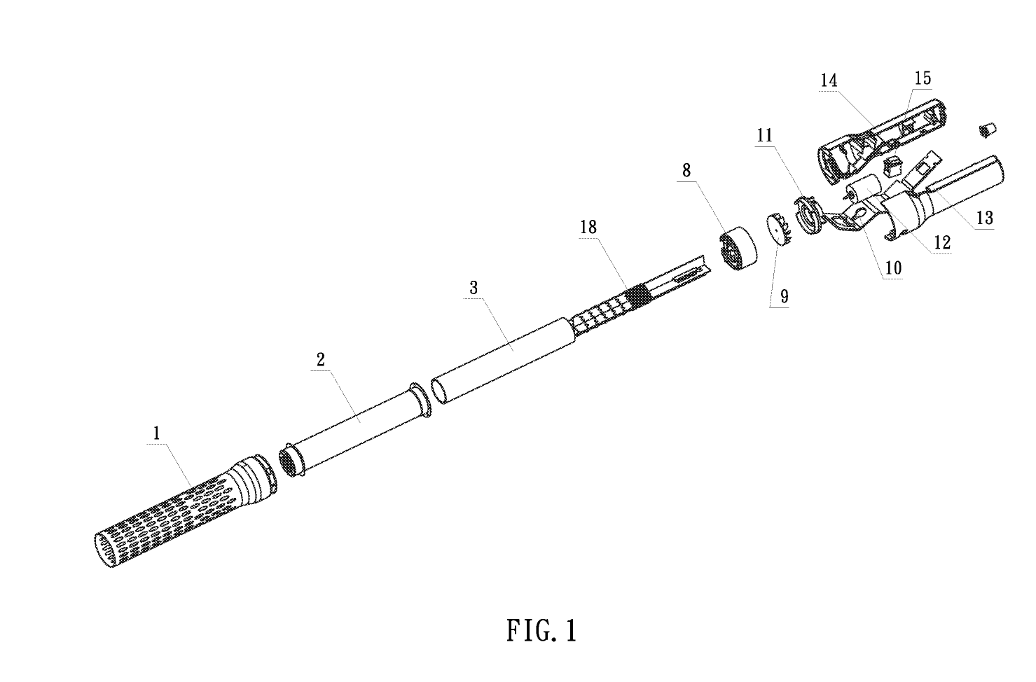

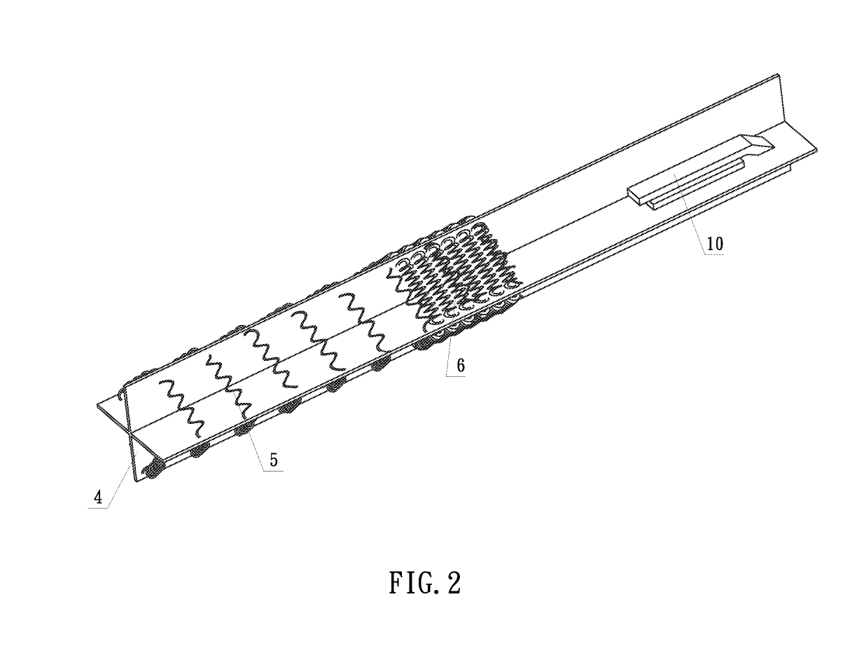

As shown in FIGS. 1 and 2, a palmtop charcoal igniter of the invention comprises a protective aluminum pipe 1, a heat insulation stainless steel pipe 2, a mica sleeve 3, a heating body 18 and a handle.

The protective aluminum pipe 1 externally configured with multiple rows of heat dissipation holes has a front end disposed with an exhaust port. The heat insulation stainless steel pipe 2 is sleeved in the protective aluminum pipe 1. The mica sleeve 3 is mounted in the heat insulation stainless steel pipe 2. The heating body 18 mounted in the mica sleeve 3 comprises an insulating mica pipe and a mica support 4. The handle mounted outside the heat insulation stainless steel pipe 2 comprises a handle left shell 13 and a handle right shell 14. A motor 12 is mounted in the handle. A motor support 11 disposed on a front end of the motor 12 allows the motor 12 passed therethrough and fixed therewith. A wind blade 9 is mounted on a front end of the motor support 11. A fan cover 8 is disposed on a front end of the wind blade 9. An igniter switch 15 disposed on a top end of the handle is configured with three shifts including an on-off shift, a cold air shift and a hot air shift.

A relatively large-sized wire heater winded around a front end of the mica support 4 of the heating body 18 is connected to the igniter switch 15. A relatively small-sized wire heater winded around a rear end of the relatively large-sized wire heater is connected to the igniter switch 15. A temperature control switch mounted on a rear end of the relatively small-sized wire heater is connected to the igniter switch 15. A supporting frame 10 is mounted on the protective aluminum pipe 1 and a lower end of the handle.

The supporting frame 10 has a W-shaped bended structure, capable of being conveniently placed at different planes. With the design of the front-end opening of the W-shaped supporting frame 10 of the invention, wine bottle caps or coverings of other beverage products can be easily opened by a user.

Besides, the exhaust port of the protective aluminum pipe 1 has a straight opened structure, capable of greatly increasing the heat transferring rate to effectively promote working efficiency.

In conclusion, efficacies of the palmtop charcoal igniter of the invention can be provided as follows.

With the additional cold air function of the invention, the user can apply the cold air for supporting combustion after charcoals, woods or other combustible matters passing through the hot air point are ignited, thereby facilitating the combustion speed of the combustible matters, avoiding of continuously using the hot air to support combustion, and saving electric energy.

Secondly, according to the additional cold air function of the invention, the user can selectively use a cold air mode or a hot air mode in the same product, viz this product capable of providing the cold or hot air for the user, thus to save the procurement costs.

Thirdly, because the temperatures of the interior and metallic portions of the wire heater are high when applying the hot air to ignite the charcoal, woods or other combustible matters, a relatively long cooling time for the wire heater is required. It is appreciated that the additional cold air function of the invention is suitable for cooling the high temperature parts of the product rapidly. Besides, by using the cold air to rapidly cool the high temperature parts of the wire heater, wires of the wire heater can be prevented from being broken due to the high temperature of the interior thereof and the mica pipe can be prevented from being ruptured due to high temperature, thereby greatly extending the life service of the product.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A palmtop charcoal igniter, characterized in that the palmtop charcoal igniter comprises a protective aluminum pipe externally configured with multiple rows of heat dissipation holes and having a front end disposed with an exhaust port, a heat insulation stainless steel pipe sleeved in the protective aluminum pipe, a mica sleeve mounted in the heat insulation stainless steel pipe, a heating body mounted in the mica sleeve and comprising an insulating mica pipe and a mica support, a handle mounted outside the heat insulation stainless steel pipe and comprising a handle right shell and a handle left shell, a motor mounted in the handle, a motor support disposed on a front end of the motor and allowing the motor passed therethrough and fixed therewith, a wind blade mounted on a front end of the motor support, a fan cover disposed on a front end of the wind blade, an igniter switch disposed on a top end of the handle and configured with three shifts including an on-off shift, a cold air shift and a hot air shift, a relatively large-sized wire heater winded around a front end of the mica support of the heating body and connected to the igniter switch, a relatively small-sized wire heater winded around a rear end of the relatively large-sized wire heater and connected to the igniter switch, a temperature control switch mounted on a rear end of the relatively small-sized wire heater and connected to the igniter switch, and a supporting frame mounted on the protective aluminum pipe and a lower end of the handle.

2. The palmtop charcoal igniter as claimed in claim 1 characterized in that the supporting frame has a W-shaped bended structure.

3. The palmtop charcoal igniter as claimed in claim 1 characterized in that the exhaust port of the protective aluminum pipe has a straight opened structure.
